(19) United States
(12) Patent Application Publication
(10) Pub. No.: US 2013/0297493 A1
(43) Pub. Date: Nov. 7, 2013

(54) METHOD FOR ENABLING GIFT PREPAY

(71) Applicant: FACEBOOK, INC., Menlo Park, CA (US)

(72) Inventors: Lee Linden, Menlo Park, CA (US); Benjamin Lewis, Menlo Park, CA (US); Abheek Anand, Menlo Park, CA (US)

(73) Assignee: FACEBOOK, INC., Menlo Park, CA (US)

(21) Appl. No.: 13/735,982

(22) Filed: Jan. 7, 2013

Related U.S. Application Data
(60) Provisional application No. 61/641,744, filed on May 2, 2012.

(51) Int. Cl. G06Q 20/28; G06Q 50/00

(52) U.S. Cl. CPC G06Q 20/28; G06Q 50/01
USPC 705/39

(57) ABSTRACT

A variation of the invention is a method that: based on an action of a recipient stored in a social networking system, identifies recipient interest in a product; based on an association between the recipient and a sender stored in the social networking system, prompts the sender to supply a fund to be applied to a purchase of the product by the recipient; requests a financial account identifier from the recipient; identifies recipient initiation of a purchase of the product from the merchant based on a financial account identifier collected, by the merchant, from the recipient; adjusts a purchase price of the product for the recipient, prior to completion of purchase, to reflect the fund supplied by the sender; generates a notification indicating purchase of the product by the recipient; and initiates transfer of the fund to the merchant in response to recipient purchase of the product.

### CROSS-REFERENCE TO RELATED APPLICATIONS

This application claims the benefit of U.S. Provisional Application No. 61/641,744, filed on May 2, 2012 and titled “Method for Selling a Product to a Sender,” which is incorporated in its entirety herein by this reference.

This application is related to: U.S. patent application Ser. No. 13/615,289, filed on Sep. 13, 2012 and titled “Method for Enabling a Gift Transaction”; U.S. patent application Ser. No. 12/978,265, filed on Dec. 23, 2010 and titled “Contextually Relevant Affinity Prediction in a Social Networking System”; U.S. patent application Ser. No. 13/239,340, filed on Sep. 21, 2011 and titled “Structured Objects and Actions on a Social Networking System”; U.S. patent application Ser. No. 12/508,521, filed on Jul. 23, 2009 and titled “Markup Language for Incorporating Social Networking Information by an External Website”; U.S. Pat. No. 8,250,145, issued on Aug. 21, 2012 and titled “Personalizing a Web Page Outside of a Social Networking System with Content from the Social Networking System”; U.S. Patent Application No. 12/969,368, filed on Dec. 15, 2010 and titled “Comment Plug-In for Third Party System”; and U.S. patent application Ser. No. 13/167,702, filed on Jun. 24, 2011 and titled “Suggesting Tags in Status Messages Based On Social Context”, all of which are incorporated in their entirety by this reference.

### TECHNICAL FIELD

This invention relates generally to the field of electronic commerce (or ‘e-commerce’), and more specifically to a new and useful method for enabling gift prepay via e-commerce.

### BACKGROUND

Gift cards account for millions of dollars in gift transactions and millions of dollars in liability for merchants annually. Monetary value is typically associated with these gift cards through stored value accounts that are accessible only through the physical gift cards themselves. Unfortunately, these cards are commonly lost, are forgotten, or otherwise fail to be applied to purchases by their recipients, and the monetary value of these cards thus remains inaccessible to their would-be owners. Furthermore, gift cards often fail to be significantly relevant to interests or needs of their recipients and thus fail to justify exchange for products or services from associated merchants.

### BRIEF DESCRIPTION OF THE FIGURES

FIG. 1A is a flowchart representation of a method of an embodiment;

FIG. 1B is a flowchart representation of a variation of the method;

FIG. 2 is a flowchart representation of Block Silo in accordance with a variation of the method;

FIG. 3 is a flowchart representation of Block S120 in accordance with a variation of the method;

FIG. 4 is a flowchart representation of Block S130 in accordance with a variation of the method;

FIG. 5 is a flowchart representation of Block S140 in accordance with a variation of the method;

FIG. 6 is a flowchart representation of Block S160 in accordance with a variation of the method;

FIG. 7 is a schematic representation of a variation of the method;

FIG. 8 is a schematic representation of a variation of the method;

FIG. 9 is a schematic representation of a variation of the method;

FIG. 10 is a schematic representation of a variation of the method;

FIG. 11 is a schematic representation of a variation of the method;

FIG. 12 is a schematic representation of a variation of the method;

FIG. 13 is a block diagram of a system environment for a social networking system; and

FIG. 14 is a block diagram of a system architecture of the social networking system.

### DESCRIPTION OF THE EMBODIMENTS

The following description of the embodiments of the invention is not intended to limit the invention to these embodiments, but rather to enable any person skilled in the art to make and use this invention.

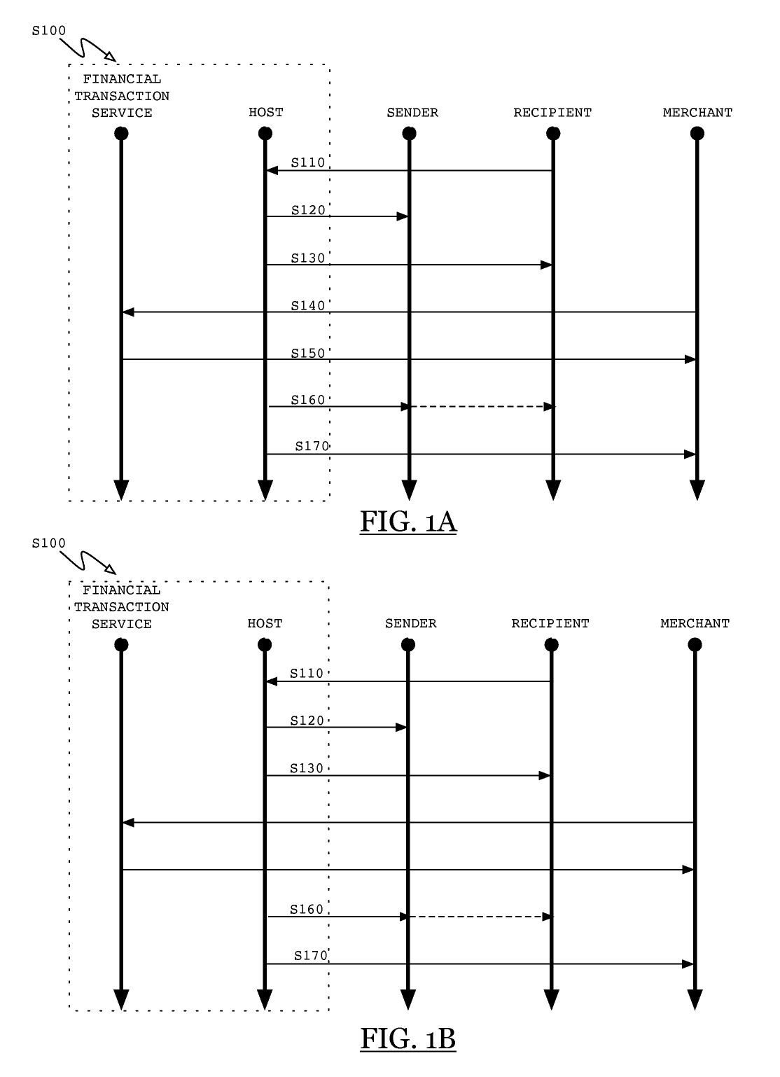

As shown in FIG. 1A, a method S100 for enabling gift prepay, includes: based on an action of a recipient stored in a social networking system, identifying recipient interest in a product (i.e. good or service) in Block S110; based on an association between the recipient and a sender stored in the social networking system, prompting the sender to supply a fund to be applied to a purchase of the good or service by the recipient in Block S120; requesting a financial account identifier from the recipient in Block S130; identifying recipient initiation of a purchase of the good or service from a merchant based on a financial account identifier collected, by the merchant, from the recipient in Block S140; adjusting a purchase price of the good or service for the recipient, prior to completion of the purchase of the good or service, to reflect the fund supplied by the sender in Block S150; generating a notification indicating purchase of the good or service by the recipient in Block S160; and initiating transfer of the fund to the merchant in response to the purchase of the good or service by the recipient in Block S170. In this variation, the sender's fund is associated with a particular good or service.

As shown in FIG. 1A, one variation of method S100 includes: based on an action of a recipient stored in a social networking system, identifying recipient interest in a merchant in Block S110; based on an association between the recipient and a sender stored in a social networking system, prompting the sender to supply a fund to be applied to a purchase of a good or service, from the merchant, by the recipient in Block S120; requesting a financial account identifier from the recipient in Block S130; identifying recipient initiation of a purchase of a good or service from the merchant based on a financial account identifier collected, by the merchant, from the recipient in Block S140; adjusting a purchase price of the good or service for the recipient, prior to completion of the purchase of the good or service, to reflect the fund supplied by the sender in Block S150; generating a notification of the purchase of the good or service, by the recipient, for publication by a social networking system in Block S160; and initiating transfer of the fund to the merchant in response to recipient purchase of the good or service from the merchant in Block S170. In this variation, the sender's fund is associated with a particular merchant.

As shown in FIG. 1B, another variation of method S100 includes: identifying an association between a recipient and a merchant based on a recipient action stored in a social networking system in Block S110; based on an association between the recipient and a sender stored in the social networking system, prompting the sender to supply a fund to be applied to a purchase of a good or service, offered by the merchant, by the recipient in Block S120; requesting a financial account identifier from the recipient in Block S130, the financial account identifier suitable to identify recipient initiation of a purchase of the good or service through comparison with a financial account identifier collected, from the recipient, by the merchant; generating a notification, for the sender, of the purchase of the good or service by the recipient in Block S160, the notification indicating application of the fund supplied by the sender to the purchase price of the good or service by the recipient; and initiating transfer of the fund to the merchant in response to recipient purchase of the good or service from the merchant in Block S170. In this variation shown in, the sender's fund can be associated with a particular good or service and/or with a particular merchant.

Method S100 can be implemented as a gift recommendation and fulfillment service that identifies recipient interest in a particular merchant or in a particular good or service, identifies a relationship between the recipient and a sender, recommends, to the sender, a gift in the form of a prepay for a good or service based on an identified interest of the recipient, and facilitates a collection of the prepay from the sender and its application to a purchase by the recipient. Generally, method S100 recommends a monetary contribution, from the sender, for recipient purchase of a particular good or service or of an item from a particular merchant in which the recipient has expressed interest. The sender thus effectively “prepays” for (all or) a portion of a future transaction between the recipient and a merchant. Method S100 then informs the recipient of the sender prepay and collects recipient identification information. When the recipient initiates a purchase for the particular good or service or from the particular merchant, method S100 compares the identification information entered by the recipient with identification information collected from the recipient by the merchant and, given a positive match, applies the sender's prepay to the transaction between the merchant and the recipient, such as in real time.

Method S100 can be implemented on one or more computer systems, such as a cloud-based computer system (e.g., Amazon EC₃), a mainframe computer system, a grid-computer system, or any other suitable computer system. Method S100 can be implemented by a social networking system, such as by Facebook, by a social networking system in cooperation with a financial transaction service, such as Facebook in cooperation with First Data Corporation, or by any other suitable entity or combination of entities. Method S100 can collect sender and/or recipient data through actions performed or information entered by the sender and recipient over the Internet, such from within a web browser or through a native application executing on an electronic device. Method S100 can also transmit public and/or private notifications, pertaining to the prepay, product, or service transaction, to the sender and recipient. Manipulation of sender and recipient data in Block S110, S120, S130, and S140 and transmission of notifications to the sender and recipient in Block S120 and S160 preferably adhere to online privacy settings selected by the sender and the recipient, such as settings set by each of the sender and the recipient within the social networking system.

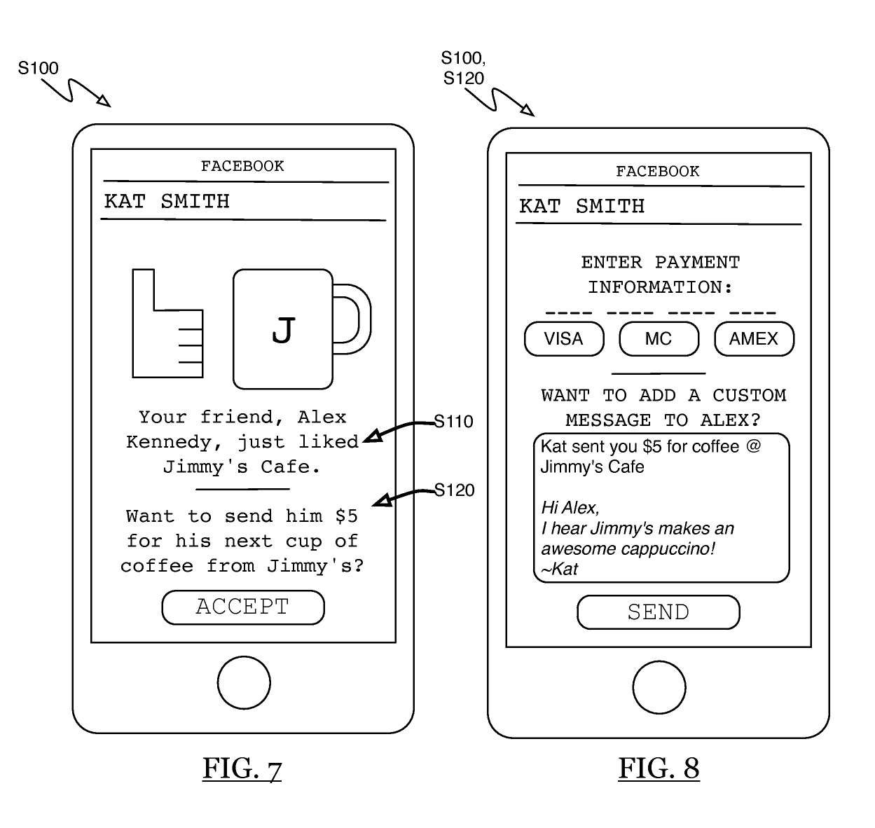

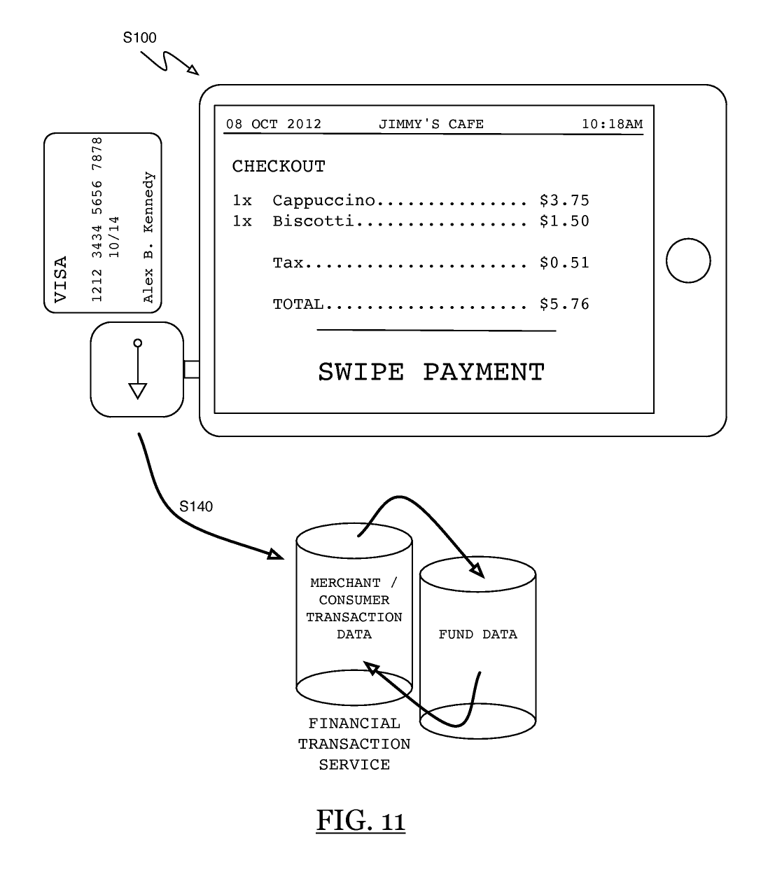

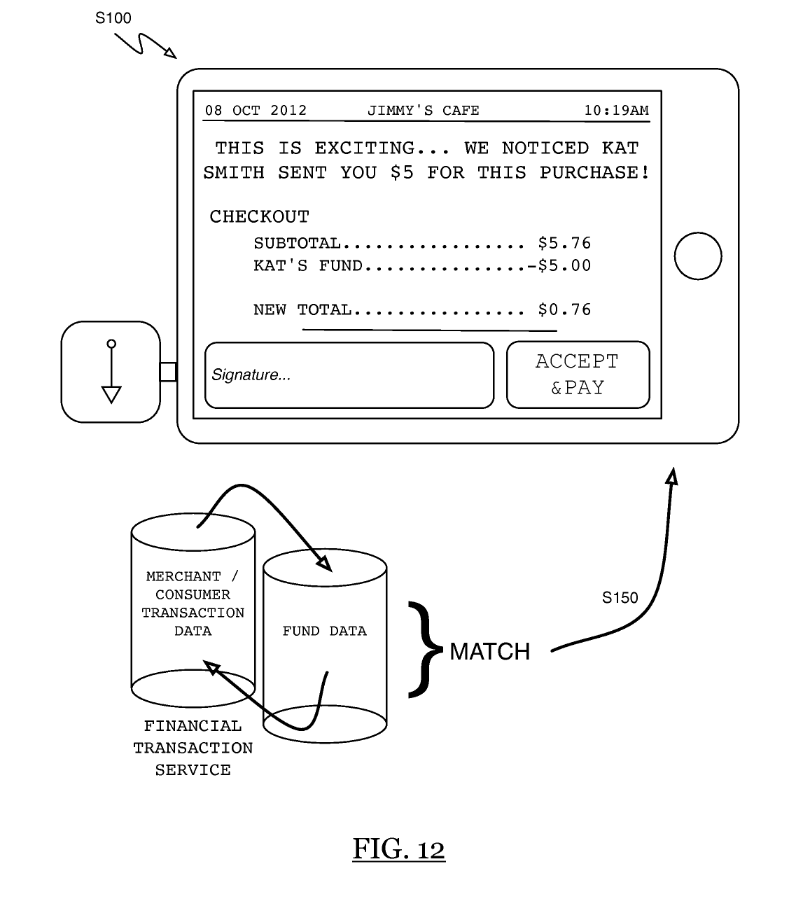

Blocks of method S100 can be accessible to the sender and the recipient through various electronic devices, such as a desktop computer, a laptop computer, a smartphone (shown in FIGS. 7-10), a tablet (shown in FIGS. 11 and 12), a personal data assistant (PDA), a personal music player, or any other suitable elective device. Method S100 can also collect data pertaining to a recipient transaction initiated at a brick-and-mortar retail location, initiated at a physical pop-up retail location, initiated through an online store accessible through a web browser, initiated through a native application executing on an electronic device, or initiated in any other way or through any other physical or electronic device or venue. The one or more computer systems that implement method S100 can therefore include one or more processors configured to identify a recipient interest, recommend a prepay to a sender, collect recipient identification information, match a recipient-merchant transaction to the prepay, adjust a transaction bill for the recipient, notify the sender of the transaction, and initiate transfer of the prepay to the merchant, though the one or more processors can fulfill any other additional functions.

The computer system can incorporate a sender-side interface (or ‘dashboard’) and a recipient-side interface. The sender-side interface can be accessible by a sender to review a recommended prepay, select from one or more recommended prepays, enter preferred details of a prepay, enter conditions of a prepay, provide payment information, review notifications of recipient transactions, etc. The recipient-side interface can be accessible by the recipient to approve, modify, exchange, customize, personalize, combine, separate, manage, etc. one or more prepays from one or more senders. Generally, the sender- and recipient-side interfaces can each be accessible through a web browser or native application executing on an electronic device, such as a laptop computer, a desktop computer, a tablet, a smartphone, a personal data assistant (PDA), or a personal music player.

Method S100 can select a product and/or services from local merchants, such as a tangible item, a real (i.e. not virtual) service, or a gift card redeemable at a local merchant. A merchant can thus define a gift and/or create a gift template within a social networking system. For example, a local business can create a gift that is a gift certificate of a set or variable value, such as $5, $10, $25, $50, or a sender-entered amount. In another example, the local business can create select a gift that is a good or service with a SKU number, such as a hot stone massage, a rock climbing lesson, dinner for two, or a bottle of wine. The local business can also specify a single gift, multiple gifts, a default gift in a list of multiple gifts, a target recipient for one or more gifts, a loyalty service for the sender or recipient, or any other factor related to commerce or gifting, and method S100 can implement any of the foregoing factors to select a gift, a sender, or a recipient, to entice the sender to send the gift, and/or to notify the sender and/or recipient of gifting details. However, the method can select any other type of product of service from any other type of merchant in any suitable location.

Method S100 can be implemented by a social networking system that enables communication between users (e.g., potential senders and recipients), contains relevant sender and/or recipient information (e.g., sender-recipient relationship status, sender or recipient demographic information, sender and/or recipient interests), tracks dates and/or occurrences of gift-appropriate events (e.g., birthdays, promotions, graduations, anniversaries), and tracks tangible and/or virtual gifts or prepays sent to the recipient by one or more senders. Additionally or alternatively, the method can be implemented by an online dating network, a single-merchant online marketplace, an online merchant aggregator, or any other suitable electronic or physical retail venue that permits allocation of a fund for a transaction prior to initiation of the transaction. However, the method can be implemented by any other entity or through any other computer system, and the method can implement any other interface(s) to send or receive prepays, funds, and/or sender- and recipient-related data (according to privacy settings of the sender and recipient).

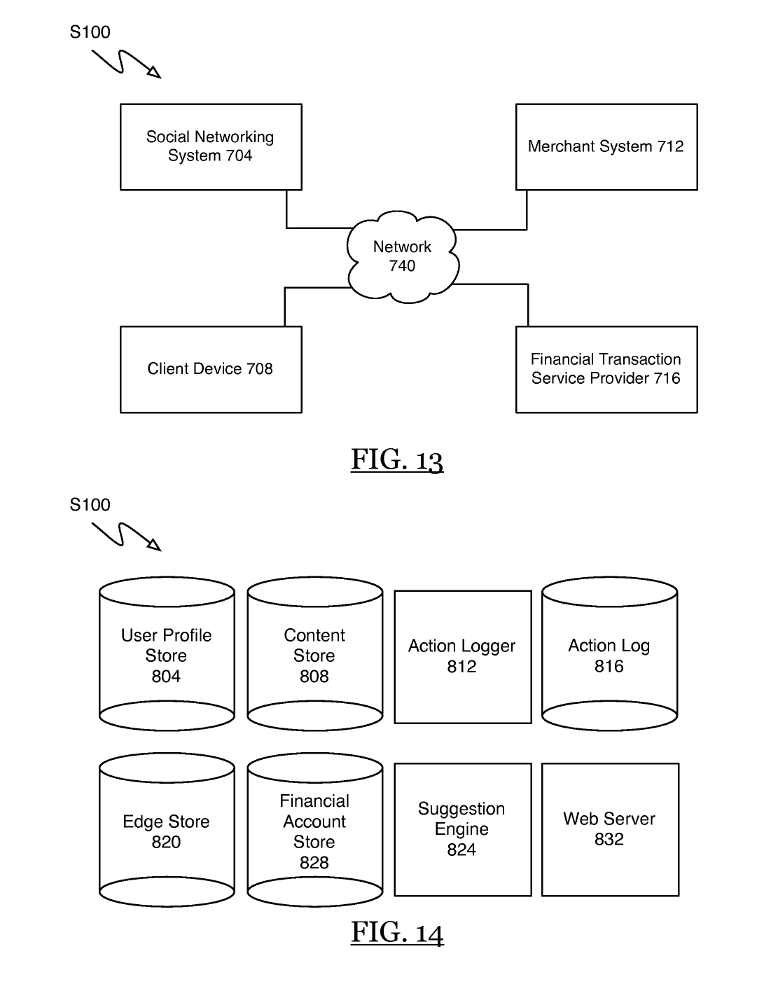

FIG. 13 is a block diagram of a system environment 100 for a social networking system 104. The system environment 100 shown in FIG. 13 includes a social networking system 104, a user device 108, a merchant system 112, a financial transaction service provider 114, and a network 140. Alternatively, the system environment 100 can include different and/or additional components than those shown in FIG. 13.

The social networking system 104, further described below in conjunction with FIG. 14, includes one or more computing devices storing user profiles associated with users and/or other objects as well as connections between users and other users and/or objects. In use, users join the social networking system 104 and then add connections to other users or objects of the social networking system to which they desire to be connected. As further described below in conjunction with FIG. 14, users of the social networking system 104 can be individuals or entities such as businesses, organizations, universities, manufacturers. The social networking system 104 allows its users to interact with each other as well as with other objects maintained by the social networking system 104. The social networking system 104 can therefore allow users to interact with third-party websites, such as the merchant system 112 and the financial transaction service 116.

Based on stored data about users, objects and connections between users and/or objects, the social networking system 104 generates and maintains a “social graph.” comprising a plurality of nodes interconnected by a plurality of edges. Each node in the social graph represents an object or user that can act on another node and/or that can be acted on by another node. An edge between two nodes in the social graph represents a particular kind of connection between the two nodes, which can result from an action that was performed by one of the nodes on the other node. For example, when a user identifies an additional user as a friend, an edge in the social graph is generated connecting a node representing the first user and an additional node representing the additional user. The generated edge has a connection type indicating that the users are friends. As various nodes interact with each other, the social networking system 104 modifies edges connecting the various nodes to reflect the interactions.

A client device 108 is a computing device capable of receiving user input as well as transmitting and/or receiving data via the network 140. In one implementation, the client device 108 is a conventional computer system, such as a desktop or laptop computer. In another implementation, the client device 140 can be a device having computer functionality, such as a personal digital assistant (PDA), mobile telephone, smart-phone or similar device. The client device 108 is configured to communicate with the social networking system 104, the merchant system 112 and/or the financial transaction service provider 116 via the network 140. In one implementation, the client device 108 executes an application allowing a user of the client device 108 to interact with the social networking system 104. For example, the client device 108 executes a browser application to enable interaction between the client device 108 and the social networking system 104 via the network 140. In another implementation, a client device 108 interacts with the social networking system 104 through an application programming interface (API) that runs on the native operating system of the client device 108, such as iOS® or ANDROID™.

The client devices 108 are configured to communicate via the network 140, which can include any combination of local area and/or wide area networks, using both wired and wireless communication systems. In one Ser. No. 13/239,340, the network 140 uses standard communications technologies and/or protocols. Thus, the network 140 can include links using technologies such as Ethernet, 802.11, worldwide interoperability for microwave access (WiMAX), 3G, 4G, CDMA, digital subscriber line (DSL), etc. Similarly, the networking protocols used on the network 140 can include multiprotocol label switching (MPLS), transmission control protocol/Internet protocol (TCP/IP), User Datagram Protocol (UDP), hypertext transport protocol (HTTP), simple mail transfer protocol (SMTP) and file transfer protocol (FTP). Data exchanged over the network 140 can be represented using technologies and/or formats including hypertext markup language (HTML) or extensible markup language (XML). In addition, all or some of the links can be encrypted using conventional encryption technologies such as secure sockets layer (SSL), transport layer security (TLS), and Internet Protocol security (IPsec).

The merchant system 112 includes one or more servers providing content associated with a merchant. For example, the merchant system 112 provides web pages describing products and/or services sold by one or more vendors. The merchant system 112 can also perform other functions to allow the merchant to provide products or services in exchange for compensation. Examples of functions provided by the merchant system 112 include maintaining accounts for purchasers, tracking inventory levels, modifying pricing of products or services, obtaining compensation for products or services from the financial transaction service provider 116 and/or other suitable actions. The merchant system 112 communicates with the social networking system 104, and/or the financial transaction service provider 116 via the network 140.

The financial transaction service provider 116 processes virtual currency transactions between a merchant and a customer, such as credit, debit, private-label, gift, payroll, a prepaid card, and/or other virtual currency, credit, or debit transaction. The financial transaction service provider 116 therefore directs a fund from a financial account of a consumer to a financial account of a merchant in response to a consumer purchase and can further direct a fund from a merchant to a consumer, such as in response to a return or exchange. The financial transaction service provider 116 can further provide fraud protection and authentication solutions, electronic check acceptance services, and/or Internet commerce and mobile payment solutions.

FIG. 14 is a block diagram of a system architecture of the social networking system 104. The social networking system 104 shown in FIG. 14 includes a user profile store 204, a content store 208, an edge store 212, an action logger 214, an action log 216, a suggestion engine 220, a financial account store 224 and a web server 228. Alternatively, the social networking website 104 can include additional, fewer, or different modules for various applications. Conventional components such as network interfaces, security mechanisms, load balancers, failover servers, management and network operations consoles, and the like are not shown so as to not obscure the details of the system architecture.

Each user of the social networking system 104 is associated with a user profile, which is stored in the user profile store 204. A user profile includes declarative information about the user that was explicitly shared by the user, and can also include profile information inferred by the social networking system 104. In one Ser. No. 13/239,340, a user profile includes multiple data fields, each data field describing one or more attributes of the corresponding user of the social networking system 104. The user profile information stored in user profile store 204 describes the users of the social networking system 104, including biographic, demographic, and other types of descriptive information, such as work experience, educational history, gender, hobbies or preferences, location and the like. A user profile can also store other information provided by the user, for example, images or videos. images of users can be tagged with identification information of users of the social networking system 104 displayed in an image. A user profile in the user profile store 204 can also maintain references to actions by the corresponding user performed on content items in the content store 208 and stored in the edge store 212.

A user profile can be associated with one or more financial accounts, which enables tracking of prepaid gifts and redemption of those gifts when using an associated financial account. A user can specify one or more privacy settings, which are stored in the user profile, that limit information from a financial account that the social networking system 104 is permitted to access. In one implementation, information from the financial account is stored in the user profile store 204. Alternatively, information can be stored in the financial account store 224.

The content store 208 stores content items associated with a user profile, such as images, videos or audio files. Content items from the content store 208 can be displayed when a user profile is viewed or when other content associated with the user profile is viewed. For example, displayed content items can show images or video associated with a user profile or show text describing a user's status. Additionally, other content items can facilitate user engagement by encouraging a user to expand his connections to other users, to invite new users to the system or to increase interaction with the social network system by displaying content related to users, objects, activities, or functionalities of the social networking system 104. Examples of social networking content items include suggested connections or suggestions to perform other actions, media provided to, or maintained by, the social networking system 104 (e.g., pictures or videos), status messages or links posted by users to the social networking system, events, groups, pages (e.g., representing an organization or commercial entity), and any other content provided by, or accessible via, the social networking system.

The content store 208 also includes one or more pages associated with entities having user profiles in the user profile store 204. An entity is a non-individual user of the social networking system 104, such as a business, a vendor, an organization or a university. A page includes content associated with an entity and instructions for presenting the content to a social networking system user. For example, a page identifies content associated with the entity's user profile as well as information describing how to present the content to users viewing the brand page. Merchants associated with merchant systems 112, further described above in conjunction with FIG. 13, can be associated with pages in the content store 208, allowing social networking system users to more easily interact with the merchant via the social networking system 104. A merchant identifier is associated with a vendor's page, allowing the social networking system 104 to identify the merchant and/or to retrieve additional information about the merchant from the user profile store 204, the action line 216 or from any other suitable source using the vendor identifier.

The action logger 212 receives communications about user actions on and/or off the social networking system 104, populating the action log 216 with information about user actions. Such actions can include, for example, adding a connection to another user, sending a message to another user, uploading an image, reading a message from another user, viewing content associated with another user, attending an event posted by another user, among others. Moreover, the actions can relate to a merchant. In one example, a user can “like” an object associated with the merchant, for example, by explicitly making that indication on the merchant's page in the social network. In another example, a user can comment on a merchant's page within the social network, share a story from the merchant's page, tag a photo associated with the merchant or a good or service provided by the merchant, become a fan of the merchant, check-in to a brick-and-mortar store of the merchant, or subscribe or follow the merchant. As described in U.S. patent application Ser. No. 13/239,340, which is incorporated herein by reference, the edge store 220 can correlate any one or more such user actions with an interest in the merchant or a product of service from the merchant, which can be useful in selection an appropriate gift for the user who is a recipient.

The action log 216 can be used by the social networking system 104 to track user actions on the social networking system 104, as well as external website that communicate information to the social networking system 104. Users can interact with various objects on the social networking system 104, including commenting on posts, sharing links, and checking-in to physical locations via a mobile device, accessing content items in a sequence or other interactions. Information describing these actions is stored in the action log 216. Additional examples of interactions with objects on the social networking system 104 included in the action log 216 include commenting on a photo album, communications between users, becoming a fan of a musician, adding an event to a calendar, joining a groups, becoming a fan of a brand page, creating an event, authorizing an application, using an application and engaging in a transaction. Additionally, the action log 216 records a user's interactions with advertisements on the social networking system 104 as well as other applications operating on the social networking system 104. Data from the action log 216 is used to infer interests or preferences of the user, augmenting the interests included in the user profile and allowing a more complete understanding of user preferences.

The action log 216 can also store user actions taken on external websites and/or determined from a financial account associated with the user. For example, an e-commerce website that primarily sells sporting equipment at bargain prices can recognize a user of a social networking system 104 through social plug-ins that enable the e-commerce website to identify the user of the social networking system 104. Because users of the social networking system 104 are uniquely identifiable, e-commerce websites, such as this sporting equipment retailer, can use the information about these users as they visit their websites. The action log 216 records data about these users, including webpage viewing histories, advertisements that were engaged, purchases made, and other patterns from shopping and buying. Actions identified by the action logger 212 from the transaction history of a financial account associated with the user allow the action log 216 to record further information about additional types of user actions.

In one embodiment, an edge store 220 stores information describing connections between users and other objects on the social networking system 104 as edge objects. Some edges can be defined by users, allowing users to specify their relationships with other users. For example, users can generate edges with other users that parallel the users' real-life relationships, such as friends, co-workers, partners, etc. Other edges are generated when users interact with objects in the social networking system 104, such as expressing interest in a page on the social networking system, sharing a link with other users of the social networking system, and commenting on posts made by other users of the social networking system. The edge store 220 stores edge objects that include information about the edge, such as affinity scores for objects, interests, and other users. For example, an affinity score between a user and a merchant can be stored. Affinity scores can be computed by the social networking system 104 over time to approximate a user's affinity for an object, interest, and other users in the social networking system 104 based on the actions performed by the user. Multiple interactions between a user and a specific object can be stored in one edge object in the edge store 220, in one embodiment. Connections between users can be stored in the user profile store 204, or the user profile store 204 can access the edge store 220 to determine connections between users.

In one implementation, the financial account store 224 includes financial account identifiers associated with user profiles and an association or mapping between a financial account and its corresponding user profile. A user can include additional information about the financial account in the financial account store, such as a description of the financial account and can also include authentication information for accessing the account such as names, passwords or other security credentials. In implementation in which information about user financial accounts are stored in the financial account store 228, the social networking system 104 can apply additional security measures (encryption, etc.) to the financial account store 228 to reduce the risk of unauthorized access to financial account information. Alternatively, financial account information can be included in the user profile store 204 as data in a user's user profile. One or more privacy settings can be applied to the financial account information to limit its accessibility to objects in the social networking system 104.

The suggestion engine 224 accesses data in the user profile store 204, user profile store 204, in the action log 216, and/or the content store 208 either individually or in combination and identifies one or more candidate products associated with vendors in which a user is likely to have an interest. Generally, the suggestion engine can analyze the action log 220, identify user actions related to one or more merchants, products, or services, calculate the user's affinity for one or more merchants, products, or services, and select a suitable gift for the user based on the user's affinity. The suggestion engine 224 can also collect offers for products from local merchants, wherein the products can be collected or fulfilled through a physical retail location and/or through e-commerce. The suggestion engine 224 can further calculate an affinity between a user who is a (potential) recipient and a second user who is a (potential) sender, such as based on interactions between the users including messages, posts, and/or other communications between the users within the social networking system, and select the second user as the sender based on the affinity between the users. The suggestion engine 224 can subsequently recommend the selected gift to the sender and facilitate sender purchase of the product for the recipient.

Actions between the user and pages maintained by the social networking system stored in the action log 216 can be used by the suggestion engine 224 to select candidate products. The suggestion engine 224 can analyze actions involving the user and various pages in the content store 208 as well as connections between the user and various pages in the edge store 220 to select candidate products. For example, the suggestion engine 228 selects candidate products based on the frequency of actions between the user and a page, the number of interactions between the user and the page, the type of connection between the user and a page, staleness of the interactions, a type of action between the user and a page or any other suitable criteria.

The financial account store 228 can store a financial account identifier of one or more user IDs or profiles within the social networking system. The financial account store 228 can cooperate with the financial transaction service provider to track gifts, gift values, gift description, gift contents, etc. for a particular merchant and control application of a gift to a recipient purchase based on an identified match between a gift and a recipient purchase at the particular merchant. For example, the financial account store 228 can analyze merchant transactions, match a user social network ID to the purchase, and select an available gift affiliated with the user and redeemable at the merchant. The financial account store 228 can then communicate this information to the financial transaction service provider to initiation deduction of the gift amount from the recipient's bill without exposing user (e.g., sender or recipient) identification information to the financial transaction service.

The web server 232 links the social networking system 104 via the network 140 to the client device 108, to the financial transaction service provider 116 and/or to the merchant system 112. The web server 232 serves web pages, as well as other web-related content, such as Java, Flash, XML and so forth. The web server 232 can provide the functionality of receiving and routing messages between the social networking system 104 and the client device 108, for example, instant messages, queued messages (e.g., email), text and SMS (short message service) messages, or messages sent using any other suitable messaging technique. A user can send a request to the web server 232 to upload information, for example, images or videos that are stored in the content store 208. Additionally, the web server 232 can provide application programming interface (API) functionality to send data directly to native client device operating systems, such as iOS®, ANDROID™, webOS® or RIM. The web server 232 also provides API functionality for exchanging data, such as financial account information, between the social networking system 104 and the financial transaction service provider 116.

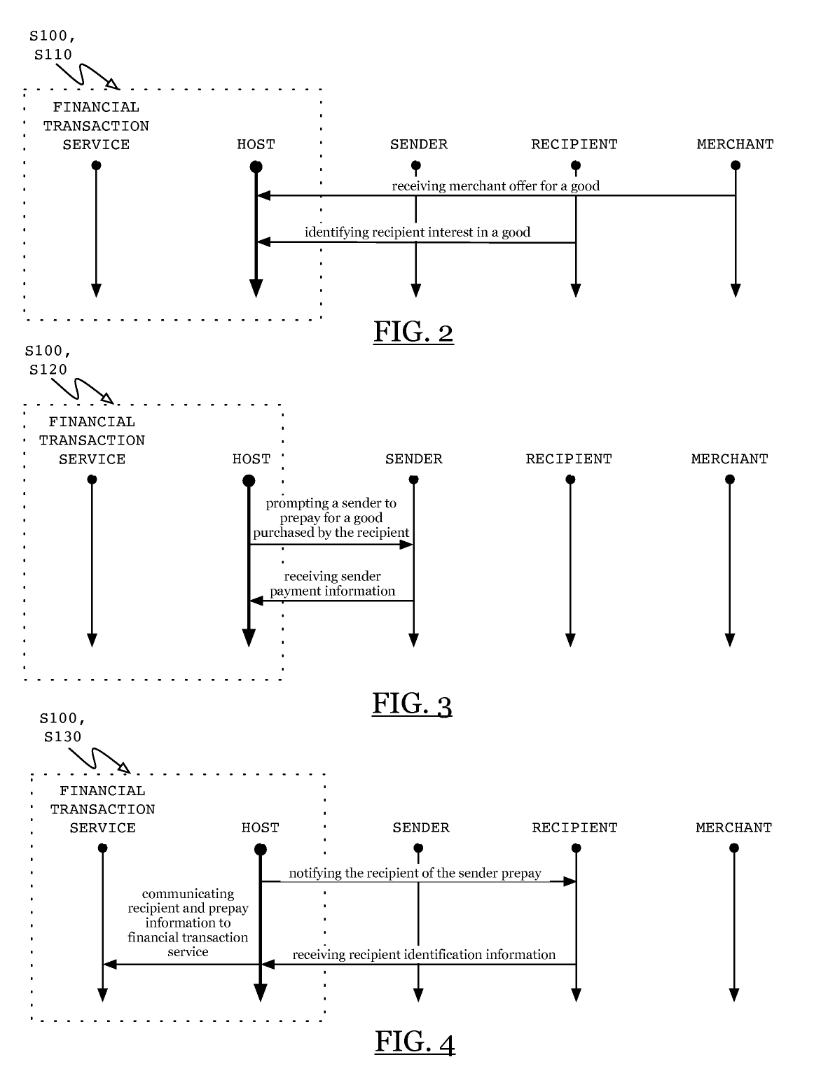

As shown in FIG. 2, Block S110 of method S100 recites identifying recipient interest in a good or service based on an action of a recipient stored in a social networking system. Alternatively, Block S110 can recite identifying recipient interest in a merchant based on an action of a recipient stored in a social networking system. Therefore, Block S110 can analyze online recipient actions to ascertain recipient interest in a particular good or service or in a particular merchant. The particular good or service can be an electronic or tangible product, a digital or analog service, or any other purchasable item or experience. For example, the good or service can be a game token, a download for an electronic game, a meal, clothing, a book in print or digital format, an electronic device, a vehicle, or a new or vintage toy. Alternatively, the particular merchant can be a merchant with either or both of a brick-and-mortar store or an electronic store (e.g., Nordstrom Rack), an online merchant aggregator (e.g., Amazon), an online or physical marketplace (e.g., Safeway), or a restaurant or cafe (e.g., Burger King). However, the particular merchant can be any other suitable type of merchant and/or the good or service can be any other suitable type of good or service.

Block S110 can identify recipient interest in the particular product, service, or merchant based on an interactive input provided by the recipient, such as through the social networking system, in reference to the particular product, service, or merchant. For example, the recipient can “like” a product or merchant by selecting a “Like” button on a website or from within the social networking system, such as through a web browser or within a native application, wherein Block S110 thus identifies the product or merchant as of interest to the recipient. In this example, by associating “likes” with a merchant, Block S110 can promote the value of “likes” for the merchant. In particular, Block S110 can associate a recipient “like” of the merchant with recipient interest in the merchant, and the method can subsequently generate a gifting recommendation that leads to a transaction between a sender and/or a recipient. In another example, the recipient can “pin” an image of a product or an image related to a merchant by similarly selecting a “Pin It” button on a website, within a native application, to otherwise from within the social networking system. In yet another example, Block S110 can identify the particular product, service, or merchant based on a need or interest of the recipient determined through analysis of recipient purchase history, such as recipient credit card history. In a similar example, Block S110 can identify the particular product, service, or merchant based on a determined recipient affinity for the particular product, service, or merchant, such as described in U.S. patent application Ser. No. 12/978,265, which is incorporated in its entirety by this reference. In this example, Block S110 can determine a recipient need, interest, and/or affinity based on a combination (e.g., weighted combination) of recipient interaction data within the social networking system and/or recipient purchase history. Furthermore, in identifying a particular product, service, or merchant from a list of multiple products, services, or merchants, Block S110 can rank recommendations for products, services, or merchants based on an recipient affinity prediction model or a recipient social contact affinity prediction model, such as described in U.S. patent application Ser. No. 12/978,265. This model can also account for other gifts sent to the recipient by other users, such as duplicates and complementary products or services, when identifying recipient need to interest.

Block S110 can additionally or alternatively identify recipient interest based on a social graph, such as described in U.S. patent application Ser. No. 13/239,340, which is incorporated in its entirety by this reference. In this implementation, Block S110 can analyze a social graph incorporating data collected outside of the social networking system, such as Internet browsing history, downloaded content (e.g., music, e-books), viewed online content (e.g., videos), search history, etc. to extract recipient preferences, interests, needs, etc. However, Block S110 can identify a need or interest of the recipient and correlate the need or interest with a product, service, or merchant in any other way.

Once Block S110 identifies the product or merchant as potentially of interest to the recipient, Block S110 can further confirm selection of the product or merchant as a suitable object of a sender prepay. In one implementation, Block S110 analyzes online actions of other users to determine a general level of interest in the product or item amongst a group of users. For example, given multiple products or services or merchants ‘liked’ by the recipient, Block S110 can select a particular product, service, or merchant with substantially more general interest (e.g., more ‘likes’) amongst other users. Block S110 can also limit consideration of general user interest based on demographics, such as by considering “likes” and “pins” by users only of gender, age, location, etc. similar to that of the recipient. In another implementation, Block S110 can analyze actions of the sender that are indicative of sender support of or interest in the product, service, or merchant. For example, given multiple products or services or merchants ‘liked’ by the recipient, Block S110 can select a particular product, service, or merchant that was also “liked” or “pinned” by the sender. However, Block S110 can implement any of the foregoing methods or techniques and/or function in any other way to confirm selection of a prepay for the particular good or service or for the particular merchant.

Furthermore, Block S110 can recite identifying an association between a recipient and a merchant based on a recipient action stored in a social networking system. Generally, Block S110 can identify an association between a merchant and the recipient based on a input provided by the recipient with reference to the merchant, an action performed by the recipient with reference to a good or service offered by the merchant, a previous recipient purchase of an item from the merchant, a previous recipient purchase of an item similar or complementary to the good or service, a social graph of the recipient, a determined recipient affinity, or based on any other suitable factor.

As shown in FIG. 3, Block S120 of method S100 recites, based on an association between the recipient and a sender stored in the social networking system, prompting the sender to supply a fund to be applied to a purchase of the particular good or service by the recipient. Alternatively, Block S120 can recite prompting the sender to supply a fund to be applied to a recipient purchase of a good or service from the particular merchant based on an association between the recipient and a sender stored in the social networking system. Block S120 can identify an association between a potential sender and the recipient by extracting relationship data pertaining to the potential sender and the recipient from the social networking system. For example, Block S120 can determine that the potential sender and recipient are friends (shown in FIG. 7), siblings, cousins, coworkers, or otherwise associated or related based on data previously entered into the social networking system by one or both of the potential sender and the recipient. Block S120 can further identify a degree of a relationship or connection between a potential sender and the recipient, such as by ranking a list of potential senders based on a determine strength of a relationship with the recipient. For example, Block S120 can rank immediate family members first, following by close friends, extended family, relatively close friends, coworkers, and, finally, acquaintances or distant friends. To determine the strength of a relationship between the recipient and a potential sender, Block S120 can assess a number of pictures uploaded to the social networking system and tagged as including both the recipient and potential sender, a number of messages communicated between the recipient and potential sender within a period of time over the social networking system, common likes and/or common check-ins between the recipient and potential sender, such as at similar times, or any other factor indicative of a relationship or connection between the recipient and potential sender.

Therefore, given a suitably strong association between the potential sender and the recipient, Block S120 can select a potential sender as a suitable entity to fulfill the prepay for the particular good or service or for the particular merchant. For example, Block S120 can determine that a potential sender who is a coworker of the recipient is a suitable entity to fulfill a $5 prepay for coffee at a local coffee shop ‘liked’ by the recipient, and Block S120 also determines that a potential sender who is a parent of the recipient is a suitable entity to fulfill a $100 prepay for a dress ‘pinned’ by the recipient. Furthermore, Block S120 can identify a particular time that is suitable for fulfillment of a prepay by a potential sender on behalf of the recipient. For example, Block S120 can determine that the recipient has an upcoming birthday, will celebrate an upcoming holiday, or has recently experienced a gift-appropriate event, such as described in U.S. patent application Ser. No. 13/615,289, which is incorporated herein by this reference. Block S120 can also track a current location of the recipient and prompt the sender to send the gift to the recipient when the recipient is at or suitably near an appropriate merchant or retailer. In one example, Block S120 monitors recipient check-ins and prompts the sender to purchase the gift for the recipient when the recipient checks in to a retailer that offers the gift for sale. Block S120 can also track the location of the recipient through a GPS module incorporated in a smartphone carried by the recipient and similarly prompt the sender to purchase the gift for the recipient. Alternatively, Block S120 can track or access data pertaining to the recipient's location and/or monitor recipient check-ins identify a retailer within a specified distance from the recipient, and select the gift that is offered by the retailers. In this implementation, Block S120 can select the gift and prompt the sender to purchase the gift for the recipient substantially in real time such that the sender has the opportunity to send the gift to the recipient when the gift may be particularly relevant or useful for the recipient. Block S130 can also notify the recipient of the gift substantially in real time (e.g., substantially immediately following sender gift confirmation). For example, Block S120 can access a recipient check-in at Philz Coffee, access “like” data of the recipient, determine that the recipient likes Philz Coffee, select a gift that is a $5 gift card at Philz Coffee, select a daughter of the recipient as the sender, and prompt the daughter to purchase the $5 gift card for her mother. Once the daughter orders the gift for her mother, Block S130 can substantially immediately notify the mother of the gift such that the mother can apply the gift to a purchase at Philz in the same visit.

Once Block S120 identifies a suitable sender, Block S120 can notify the sender of an opportunity to gift a prepay to the recipient, as shown in FIG. 7. In one implementation, Block S120 notifies the sender through a private message, such as an email, SMS text message, in-app notification on a smartphone or tablet carried by the sender, or a private message within the social networking system. Block S120 can also notify the sender through an applet interfacing with a web browser or a gifting ‘skin’ overlaid on a website viewed by the sender. Block S120 can also suggest the prepay to the sender from directly within a website. For example, Block S120 can be implemented as a “Prepay” or “Gift” button inline with “Like” and “Pin It” buttons adjacent an image of a good or service, such as displayed on a wall or timeline of the recipient or displayed on a merchant website. In another implementation, Block S120 notifies the sender through a public message, such as a public message posted to a social networking wall or timeline of the sender and accessible to additional users, which can further incentivize the sender to fulfill the prepay by enabling implicit or explicit social pressure from other users who view the public message.

Block S120 can generate the message, for the sender, that includes any one or more of identification of the recipient, a suggestion to prepay for a particular product, service, or merchant of interest to the recipient, details of the particular product, service, or merchant, a suggested prepay value, a prompt to define release conditions of the prepay, a prompt to add a custom message to the recipient (shown in FIG. 8), a prompt to select digital “packaging” for a notification to the recipient of the prepay, and/or any other suitable information or prompt. Block S120 can further generate the message that includes multiple suitable prepay options for the sender. For example, Block S120 can generate the message that is a private message within the social networking system, the message including an image of the recipient, an image of a local coffee shop ‘liked’ by the recipient, and one-click options to purchase one of a $3 prepay for a recipient purchase at the coffee shop, a $5 prepay for a recipient purchase at the coffee shop, or a prepay for 50% of the recipient's next purchase up to $10 at the coffee shop.

Block S120 can notify the sender of the prepay opportunity in the message that further prompts the sender to supply payment information, as shown in FIG. 8. Payment information thus collected from the sender is subsequently used to access the fund to be applied to the recipient purchase, such as in Block S150 and Block S170. For example, the message can prompt the sender to link a credit card, a debit card, a checking account, a Paypal account, or any other suitable financial (e.g., currency) account to the prepay, as shown in FIG. 8. Alternatively, Block S120 can prompt the sender to link a non-financial account to pay for the prepay, such as a social network points account. Block S120 can associate sender entry of a payment option as sender commitment to the prepay, or Block S120 can first prompt the sender to accept the prepay and subsequently request payment information. Block S120 can alternatively prompt the sender, through the message, to accept the prepay and subsequently access previously-stored sender payment information to fulfill payment for the prepay.

Generally, Block S120 can notify the sender of the opportunity to prepay, can capture sender acceptance of the prepay, and can collect sender payment information, either from within the message, by directing the sender through the message to the sender-side interface, and/or by directing the sender through the message to another or external website. However, Block S120 can notify the sender of the opportunity to prepay, can capture sender acceptance of the prepay, and can collect sender payment information in any other way.

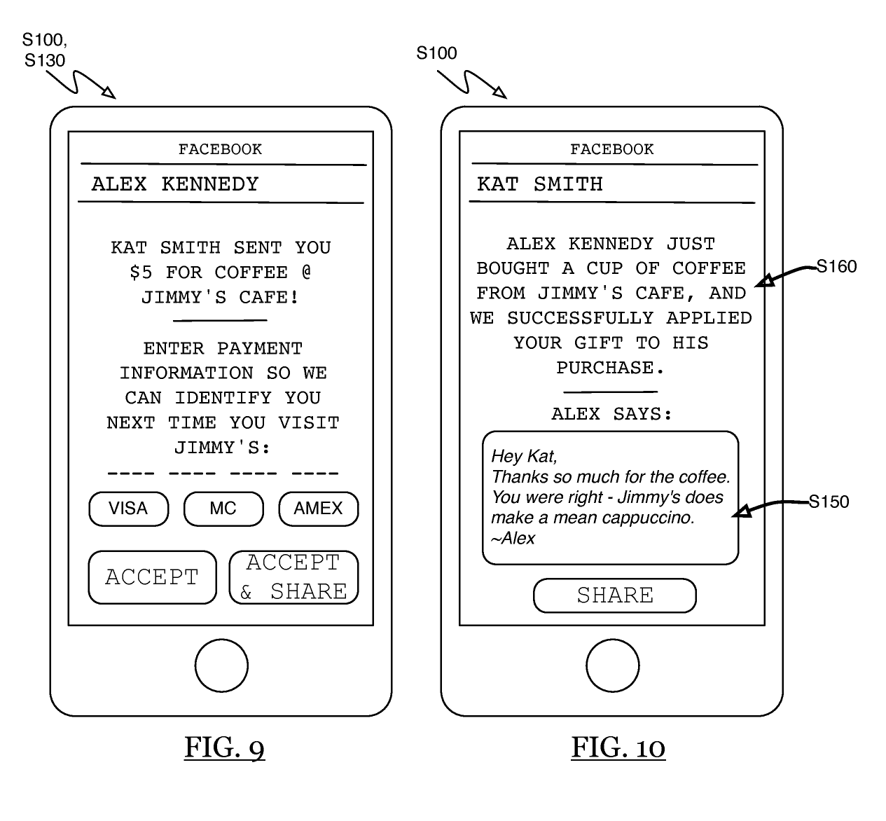

As shown in FIG. 4, Block S130 of method S100 recites requesting a financial account identifier from the recipient. Generally, Block S130 functions to notify the recipient of the fund supplied by the sender in the form of a prepay and then to collect identifying information from the recipient for subsequent use in Block S140. In one implementation, Block S130 notifies the recipient through a private message, such as an email, SMS text message, in-app notification on a smartphone or tablet carried by the recipient, or a private message sent through the recipient's profile within the social networking system, as shown in FIG. 9. Block S130 can generate the private message that, in addition to informing the recipient of the prepay, also prompts the recipient to accept the prepay and/or to modify the prepay, such as described in U.S. patent application Ser. 13/615,289. In this implementation, once the recipient accepts the fund gifted to the recipient by the sender, Block S130 can further publicize the gift, such as to friends or contacts of the recipient as stored in the social networking system. For example, Block S130 can generate a public message, including details of the gift (e.g., the sender, the recipient, the fund, and a description of the particular good or service or the particular merchant), and post the message to the wall or timeline of the sender and/or recipient, such as in accordance with privacy settings of the sender and/or recipient. In another implementation, Block S130 can notify the recipient of the sender's prepay directly through a public message. For example, Block S130 can publish a public message of the prepay to a timeline of the recipient within the social networking system, such as in accordance with privacy settings of the recipient.

Once Block S130 notifies the recipient of the prepay and the recipient accepts the fund, from the sender, to be applied to a future purchase, Block S130 collects identification information from the recipient, as shown in FIG. 9. The identification information supplied by the recipient is preferably a payment method that the recipient will subsequently also use to initiate purchase of the particular good or service or to initiate a purchase from the particular merchant. Therefore, the identification information can be a credit card number or a debit card number. Additionally or alternatively, Block S130 can collect a checking account number, a driver's license number, a social security number, or any other suitable form of identification.

Similar to Block S120, Block S130 can prompt the recipient to accept the fund, modify the conditions of the fund, share details of the fund through the social networking system, and/or supply additional identification information. Block S130 can perform any one or more of these functions from directly within the message, by directing the recipient to the recipient-side interface through the message, and/or by directing the recipient to another or external website through the message. However, Block S130 can notify the recipient of the sender's gift and collect recipient identification information in any other way.

Like Block S120, Block S130 can also notify the recipient of the gift when the recipient is in close proximity to a merchant or retailer that offers the good or service. For example, Block S130 can withhold, from the recipient, a notification of a gift from the sender until the recipient is substantially proximal a merchant or physical retailer that offers the gift. Block S130 can additionally or alternatively issue reminders to use a previous gift when the recipient is substantially proximal a valid merchant. For example, Block S130 can monitor recipient check-ins or recipient GPS data, such as according to recipient privacy settings.

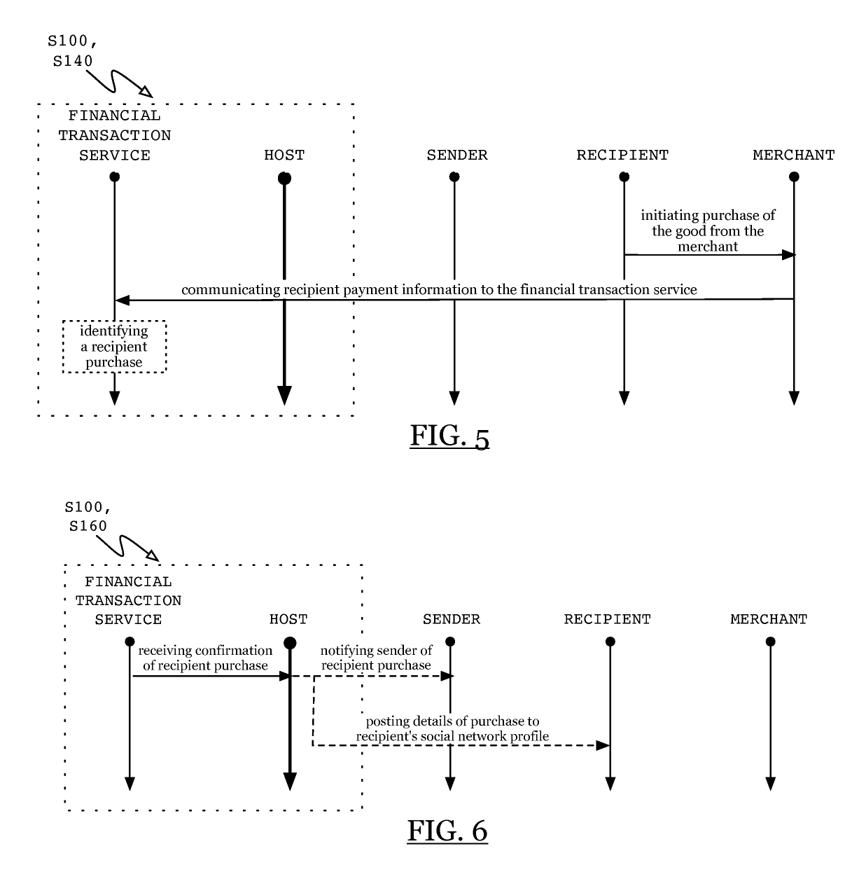

As shown in FIG. 5, Block S140 of method S100 recites identifying recipient initiation of a purchase of the particular good or service from a merchant based on a financial account identifier collected, by the merchant, from the recipient. Block S140 can alternatively recite identifying recipient initiation of a purchase of a good or service from the particular merchant based upon a financial account identifier collected, by the merchant, from the recipient.

Block S150 of method S100 recites adjusting a purchase price of the good or service for the recipient, prior to completion of the purchase of the good or service, to reflect the fund supplied by the sender. Block S140 and Block S150 can therefore cooperate to identify applicability of the sender's fund to a purchase by the recipient and then apply the sender's fund to the recipient's purchase.

After the sender submits and the recipient accepts the fund, the recipient can initiate a purchase from a merchant, through an electronic (e.g., online) store or physical retail location, by selecting a good or service and supplying a payment method to the merchant, as shown in FIG. 11. The payment method can be a credit card, a debit card, or any other suitable electronic payment method of which the merchant (customarily) communicates details to a financial transaction service (e.g., First Data Corporation, Chase Merchant Services, Wells Fargo, etc.) or to the host (e.g., Facebook). Through Block S140, the financial transaction service or the host can then match the identification information collected from the recipient in Block S130 to the recipient's payment information transmitted from the merchant at the time of purchase, as shown in FIG. 12. Based on a positive match between the fund and the purchase, the financial transaction service or the host, through Block S150, can adjust a bill (e.g., payment amount) of the recipient's purchase to reflect the fund supplied by the sender. The financial transaction service or the host can then communicate the receipt for the adjusted bill back to merchant to complete the purchase, as shown in FIG. 12, and the recipient can thus review application of the sender's fund substantially in real time.

Similarly, Block S140 can support a database of pre-paid customers, including the recipient and an associated gift amount, type, or other gift detail. Block S140 can also enable a local merchant to access this database upon recipient checkout. For example, Block S140 can enable a merchant to view gifts redeemable at the store from a list of gifts arranged alphabetically by recipient name and accessible over the Internet. In another example, Block S140 can enable merchant access to a limited profile of the recipient, such as name, photograph, and gift description, and the merchant can honor the gift and accordingly mark the gift as honored. In yet another example, Block S140 can enable the recipient to show a limited recipient profile with a description of the gift, and the merchant can view details of the gift and mark it as honored. In either of the foregoing examples, the profile can be a limited social network profile of the recipient, an email in the recipient's inbox, or any other media containing relevant recipient gift information. The profile, email, recipient gift list, database, etc. can also include a barcode or other digital media that the merchant can scan in order to capture relevant gift information and/or complete recipient check out.

Therefore, Block S140 can associate the fund committed by the sender with a purchase by the recipient substantially in real time, and Block S150 can adjust the recipient's payment amount for the purchase to reflect the sender's fund and inform the recipient of application of the sender's fund to the recipient's purchase also substantially in real time, as shown in FIGS. 11 and 12.

Alternatively, once the sender submits and the recipient accepts the fund, the recipient can complete a purchase from a merchant, such as through an electronic store or physical retail location. Following this transaction, the financial transaction service or the host, through Block S140, can match details of the transaction with identification information collected from the recipient in Block S130 and fund information collected from the sender in Block S120. The financial transaction service or the host, through Block S150, can then reimburse the recipient for the purchase according to the sender's fund. Block S150 can also notify the recipient of the reimbursement, such as through an email, a SMS text message, a private message delivered through the social networking system, or a bank statement or other financial statement. Block S140 and Block S150 can therefore associate the fund committed by the sender with a purchase by the recipient, adjust the recipient's payment amount for the purchase to reflect the sender's fund, and inform the recipient of application of the sender's fund to the recipient's purchase post hoc.

Block S140 can match the recipient's purchase to the recipient's identification information collected in Block S130 by comparing any one or more of credit card, debit card, checking account, driver's license, email address, social network username, social network profile, or other suitable financial or non-financial identifying information of the recipient. Block S140 can additionally or alternatively access global positioning system (GPS) information of the recipient at or near the time of purchase. For example, Block S140 can include collecting GPS data from a cellular phone, tablet, or other electronic device carried by the recipient and matching the collected GPS data with a known GPS coordinate of a physical retail location of a merchant associated with the prepay to determine that the recipient is in a suitable location to fulfill a purchase condition specified in the prepay. Block S140 can similarly track recipient check-ins to determine if the recipient was or is currently located at a merchant retail location suitable to fulfill conditions of the prepay. Block S140 can additionally or alternatively track recipient online activity, such as in real time, to determine if the recipient is visiting an online store of the particular merchant or has selected the particular good or service specified in the prepay. However, Block S140 can associate a recipient purchase with the sender prepay in any other way.

Block S140 can further compare the recipient's purchase with conditions associated with the prepay and/or set by sender. For example, conditions can be attached to the prepay, such as in Block S120, that include a particular physical retail location of a merchant, an expiration period of the prepay, a minimum or maximum quantity of products or services to be purchased, a configuration of the particular good or service, an option for the particular good or service, a minimum or maximum purchase value, or any other detail relevant to the good or service or to the merchant. Block S140 can compare these conditions with details of the recipient's purchase, such as collected by the merchant, to determine if the prepay is applicable to the recipient's purchase. If Block S140 determines that the recipient's purchase is appropriate for the prepay, Block S150 can subsequently adjust the purchase price of the good or service accordingly. However, if Block S140 determines that the recipient's purchase fails to fulfill requirements of the prepay, Block S150 can overlook the recipient's purchase and wait to apply the sender's fund to a future purchase that does fulfill the prepay requirements. Alternatively, if Block S140 determines that the recipient's purchase fails to fulfill requirements of the prepay, Block S140 can communicate a message to the merchant (e.g., via a receipt) or to the recipient (e.g., via a SMS text message) to alert the merchant or recipient, respectively, of a modification to the purchase necessary to fulfill requirements of the prepay. However, Block S140 can function in any other way to identify recipient initiation of an applicable purchase.

Block S150 can adjust the purchase price of the good or service purchased by the recipient by decrementing the purchase price of the good or service by the value of the fund supplied by the sender, as shown in FIG. 12. Alternatively, Block S150 can decrement the purchase price of the good or service by less than the value of the fund supplied by the sender. For example, Block S150 can set aside a portion of the value of the fund as a service fee or a convenience fee for the gifting service enabled by the host. However, Block S150 can function in any other way to adjust the purchase price of the good or service, for the recipient, in either real time or post hoc.

In one variation of method S100, Block S140 can alternatively pass the financial account identifier of the recipient, an identifier of the good or service, and details of the fund supplied by the sender to a financial transaction service that monitors transactions between the consumer and the merchant. In this variation, identification of the recipient's purchase that is available for the sender's fund is performed by the financial transaction service that, in this variation, is not associated with the host or entity that implements Block S110, Block S120, Block S130, Block S160, and S170.

As shown in FIG. 6, Block S160 of method S100 recites generating the notification indicating purchase of the good or service by the recipient. Block S160 can alternatively generate the notification of the purchase of the good or service, by the recipient, for publication by a social network. Block S160 can also recite generating the notification, for the sender, of the purchase of the good or service by the recipient, the notification indicating application of the fund supplied by the sender to the purchase of the good or service by the recipient. Generally, Block S160 functions to inform the sender that the fund was successfully applied to a recipient purchase, such as for a particular good or service or from a particular merchant, as shown in FIG. 10. In one implementation, Block S160 communicates a private message to the recipient, such as an email, SMS text message, private message communicated through the social networking system, or an in-app notification accessible on a smartphone. In another implementation, Block S160 generates a public notification for publication on the social networking system. For example, as shown in FIG. 6, Block S160 can post a public message, indicating a purchase by the recipient and application of the fund from the sender, to the wall or timeline of the recipient, such as in accordance with privacy settings of the sender and/or recipient. In this example, the message can inform the sender and friends, family, coworkers, and/or other recipient contacts of details of the gift and transaction.

Block S160 can generate the message that includes details of the recipient's purchase, such as in accordance with privacy settings selected by the recipient and/or sender from within the social networking system. For example, Block S160 can compose the message that includes an identity of the sender and/or recipient, when and where the recipient initiated the transaction, a description of the purchased good or service, a description of the merchant, the value of the purchase, and/or the value of the fund supplied by the sender. Block S160 can also prompt the recipient to draft a thank you note for the sender or to take a picture of the product, service, and/or merchant for the sender, and Block S160 can further include the note and/or picture in the message. However, Block S160 can generate any number of public or private messages of any other form and can function in any other way to inform the sender, recipient, and/or other social network users of the recipient's purchase and successful application of the sender's fund. Block S160 can further add recipient and/or sender purchase data to a social graph related to one or both the recipient and sender, such as to inform future sender, recipient, and/or gift selections.

Block S170 of method S100 recites initiating transfer of the fund to the merchant in response to the purchase of the good or service by the recipient. The method can retain the fund collected from the sender in Block S120 until the recipient completes the purchase in accordance with conditions associated with the prepay. Block S170 can thus function to release the fund, such as from the host, to the merchant from which the recipient purchased the good or service. Block S170 can initiate transfer of the fund to the merchant immediately following the recipient's purchase, after a specified period of time following the recipient's purchase, on a particular date following the recipient's purchase, according to a recurring weekly or monthly schedule, following a trigger outside of the recipient's purchase, or according to any other schedule or trigger. Fund release can be in the form of virtual currency, credit, cash, a check, or any other suitable form of currency. However, Block S170 can control release of the fund to the merchant in any other way or according to any other schema.

The methods of the embodiment can be embodied and/or implemented at least in part as a machine configured to receive a computer-readable medium storing computer-readable instructions. The instructions can be executed by computer-executable components integrated with a computer system, application, applet, host, financial transaction service, server, network, website, communication service, communication interface, hardware/firmware/software elements of a user computer, or mobile device, or any suitable combination thereof. Other systems and methods of the embodiments can be embodied and/or implemented at least in part as a machine configured to receive a computer-readable medium storing computer-readable instructions. The instructions can be executed by computer-executable components integrated by computer-executable components integrated with apparatuses and networks of the types described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

We claim:

1. A method comprising:
based on an action of a recipient stored in a social networking system, identifying recipient interest in a product;
based on an association between the recipient and a sender stored in the social networking system, prompting the sender to supply a fund to be applied to a purchase of the product by the recipient;
requesting a financial account identifier from the recipient;
identifying recipient initiation of a purchase of the product from a merchant based on a financial account identifier collected, by the merchant, from the recipient;
adjusting a purchase price of the product for the recipient, prior to completion of the purchase of the product, to reflect the fund supplied by the sender;
generating a notification indicating purchase of the product by the recipient; and
initiating transfer of the fund to the merchant in response to the purchase of the product by the recipient.

2. The method of claim 1, wherein identifying recipient interest in the product comprises identifying recipient interest in the product based on an action performed by the recipient, through the social networking system, in reference to the product.

3. The method of claim 1, wherein prompting the sender to supply the fund comprises prompting the sender to supply the fund based on a relationship between the sender and the recipient and stored in the social networking system.

4. The method of claim 1, wherein requesting the financial account identifier from the recipient comprises requesting a credit card number associated with the recipient, and wherein identifying recipient initiation of the purchase of the product comprises comparing the credit card number associated with the recipient with a credit card number supplied to the merchant, by the recipient, to purchase the product.

5. The method of claim 1, wherein requesting the financial account identifier from the recipient comprises notifying the recipient, through the social networking system, of the fund to be applied to recipient purchase of the product.

6. The method of claim 1, wherein generating the notification for the sender comprises transmitting to the sender, through the social networking system, the notification that identifies the recipient, the product, and the application of the fund toward the recipient purchase of the product.

7. The method of claim 1, wherein generating the notification comprises posting the notification to a profile of the recipient within the social networking system in accordance with privacy settings selected by the recipient.

8. The method of claim 1, wherein generating the notification for the sender comprises generating the notification that comprises an identity of the recipient, an identity of the sender, an identifier of the product, and a physical retail location of the merchant at which the recipient purchased the product.

9. The method of claim 1, wherein adjusting the purchase price of the product for the recipient comprises decrementing the purchase price of the product by the value of the fund.

10. The method of claim 1, wherein initiating transfer of the fund to the merchant comprises initiating transfer of the fund to the merchant in response to purchase of the product by the recipient.

11. A method comprising:
based on an action of a recipient stored in a social networking system, identifying recipient interest in a merchant;
based on an association between the recipient and a sender stored in a social networking system, prompting the sender to supply a fund to be applied to a purchase of a product, from the merchant, by the recipient;
requesting a financial account identifier from the recipient;
identifying recipient initiation of a purchase of a product from the merchant based on a financial account identifier collected, by the merchant, from the recipient;
adjusting a purchase price of the product for the recipient, prior to completion of the purchase of the product, to reflect the fund supplied by the sender;
generating a notification of the purchase of the product, by the recipient, for publication by a social networking system; and
initiating transfer of the fund to the merchant in response to recipient purchase of the product from the merchant.

12. The method of claim 11, wherein identifying recipient interest in the merchant comprises identifying recipient interest in the merchant based on an action performed by the recipient, through the social networking system, in reference to the merchant.

13. The method of claim 12, wherein prompting the sender to supply the fund comprises selecting the merchant from a set of merchants positively associated with the recipient based on a number of actions provided other users with the social networking system.

14. The method of claim 11, wherein requesting the financial account identifier from the recipient comprises notifying the recipient, through the social networking system, of the fund to be applied to recipient purchase of a product from the merchant.

15. The method of claim 11, wherein requesting the financial account identifier from the recipient comprises notifying the recipient, through an electronic merchant interface associated with the merchant, of the fund to be applied to recipient purchase of a product from the merchant.

16. The method of claim 11, wherein generating the notification for the sender comprises transmitting to the sender, through the social networking system, the notification that identifies the recipient, the merchant, and the application of the fund toward the recipient purchase of the product.

17. The method of claim 11, wherein identifying recipient initiation of the purchase of the product comprises matching the location of the recipient to a retail location of the merchant by accessing GPS data of an electronic device carried by the recipient.

18. The method of claim 11, wherein initiating transfer of the fund to the merchant comprises initiating transfer of the fund to the merchant in response to recipient purchase of the product, from the merchant, that conforms to a fund release condition specified by the sender.

19. A method comprising:
identifying an association between a recipient and a merchant based on a recipient action stored in a social networking system;
based on an association between the recipient and a sender stored in the social networking system, prompting the sender to supply a fund to be applied to a purchase of a product, offered by the merchant, by the recipient;
requesting a financial account identifier from the recipient, the financial account identifier suitable to identify recipient initiation of a purchase of the product through comparison with a financial account identifier collected, from the recipient, by the merchant;
generating a notification, for the sender, of the purchase of the product by the recipient, the notification indicating application of the fund supplied by the sender to the purchase of the product by the recipient; and
initiating transfer of the fund to the merchant in response to recipient purchase of the product from the merchant.

20. The method of claim 19, wherein identifying the association between the recipient and the merchant comprises identifying recipient interest in the product offered by the merchant based on an action performed by the recipient, through the social networking system, in reference to the product.

21. The method of claim 20, wherein prompting the sender to supply the fund comprises notifying the sender of the identified recipient interest in the product.

22. The method of claim 19, wherein prompting the sender to supply the fund comprises prompting the sender to supply the fund based on a relationship between the sender and the recipient and stored in the social networking system.

23. The method of claim 19, wherein requesting the financial account identifier from the recipient comprises requesting a credit card number associated with the recipient, wherein the credit card number associated with the recipient is suitable to identify recipient initiation of the purchase of the product through comparison with a credit card number supplied to the merchant, by the recipient, to purchase the product.

24. The method of claim 19, wherein requesting the financial account identifier from the recipient comprises notifying the recipient, through the social networking system, of the fund to be applied to recipient purchase of the product.

25. The method of claim 19, wherein generating the notification for the sender comprises transmitting to the sender, through the social networking system, the notification that identifies the recipient, the product, and application of the fund to the recipient purchase of the product.

26. The method of claim 19, wherein initiating transfer of the fund to the merchant comprises initiating transfer of the fund to the merchant in response to recipient purchase of the product from the merchant.

27. The method of claim 19, further comprising passing the financial account identifier of the recipient, an identifier of the product, and details of the fund supplied by the sender to a financial transaction service that monitors transactions between consumer and the merchant.
